(19) United States
(12) Patent Application Publication
(10) Pub. No.: US 2022/0137930 A1
(43) Pub. Date: May 5, 2022

(54) TIME SERIES ALIGNMENT USING MULTISCALE MANIFOLD LEARNING

(71) Applicant: ADOBE INC., SAN JOSE, CA (US)

(72) Inventors: Sridhar Mahadevan, Morgan Hill, CA (US); Anup Rao, San Jose, CA (US); Jennifer Healey, San Jose, CA (US); Georgios Theocharous, San Jose, CA (US)

(21) Appl. No.: 17/089,838

(22) Filed: Nov. 5, 2020

(51) Int. Cl. G06F 7/78; G06F 17/14; G06F 17/16; G06K 9/62

(52) U.S. Cl. CPC G06F 7/78; G06K 9/6215; G06F 17/16; G06F 17/148

(57) ABSTRACT

Systems and methods are described for performing dynamic time warping using diffusion wavelets. Embodiments of the inventive concept integrate dynamic time warping with multi-scale manifold learning methods. Certain embodiments also include warping on mixed manifolds (WAMM) and curve wrapping. The described techniques enable an improved data analytics application to align high dimensional ordered sequences such as time-series data. In one example, a first embedding of a first ordered sequence of data and a second embedding of a second ordered sequence of data may be computed based on generated diffusion wavelet basis vectors. Alignment data may then be generated for the first ordered sequence of data and the second ordered sequence of data by performing dynamic time warping.

### BACKGROUND

The following relates generally to data analytics, and more specifically to dynamic time warping.

Data analytics is the process of inspecting, cleaning, transforming, and modeling data. In some cases, data analytics systems may include components for discovering useful information, collecting information, informing conclusions, and supporting decision-making. Data analysis can be used to make decisions in a business, government, science, or personal context. Data analysis includes a number of subfields including data mining, business intelligence, etc.

In some cases, data may be arranged as time-series data in ordered sequences. Time series data includes a series of data points indexed in a time order (e.g., a sequence of data where each data element is spaced by equal intervals in time). In some cases, two sequences of time series data may be ordered with similar shape and amplitude, however the two sequences of time series data may appear de-phased (e.g., out-of-phase) in time. Dynamic time warping (DTW) may be implemented to align time series data sets such that two sequences of time series data may appear in phase prior to subsequent distance measurements between the two sequences (e.g., prior to analysis of the similarities and differences between the two sequences time series data).

Data analytics applications such as MATLAB© or R may be used to perform dynamic time warping. For instance, a motion time series captured on video may be aligned with other motion sequences, which may allow for modeling and characterizations of the captured motion time series data. However, conventional data analytics applications fail to produce accurate results when the ordered sequences include high dimensional data. Therefore, there is a need in the art for an improved data analytics application that can perform dynamic time warping on high-dimensional data.

### SUMMARY

Systems and methods are described for performing dynamic time warping using diffusion wavelets. Embodiments of the inventive concept integrate dynamic time warping with multi-scale manifold learning methods. Certain embodiments also include warping on mixed manifolds (WAMM) and curve wrapping. The described techniques enable an improved data analytics application to align high dimensional ordered sequences such as time-series data. In one example, a first embedding of a first ordered sequence of data and a second embedding of a second ordered sequence of data may be computed based on generated diffusion wavelet basis vectors. Alignment data may then be generated for the first ordered sequence of data and the second ordered sequence of data by performing dynamic time warping.

A method, apparatus, non-transitory computer-readable medium, and system for dynamic time warping are described. Embodiments of the method, apparatus, non-transitory computer-readable medium, and system are configured to receive a first ordered sequence of data and a second ordered sequence of data, generate diffusion wavelet basis vectors at a plurality of scales, wherein each of the scales corresponds to a power of a diffusion operator, compute a first embedding of the first ordered sequence of data and a second embedding of the second ordered sequence of data based on the diffusion wavelet basis vectors, generate alignment data for the first ordered sequence of data and the second ordered sequence of data by performing dynamic time warping based on the first embedding and the second embedding, and transmit the alignment data in response to receiving the first ordered sequence of data and the second ordered sequence of data.

A method, apparatus, non-transitory computer-readable medium, and system for dynamic time warping are described. Embodiments of the method, apparatus, non-transitory computer-readable medium, and system are configured to receive a first ordered sequence of data and a second ordered sequence of data, compute a first embedding of the first ordered sequence of data and a second embedding of the second ordered sequence of data based on diffusion wavelet basis vectors corresponding to a plurality of scales of a diffusion operator, compute an alignment matrix identifying an alignment between the first ordered sequence of data and the second ordered sequence of data, update the first embedding, the second embedding and the alignment matrix in a loop until a convergence condition is met, and generate alignment data for the first ordered sequence of data and the second ordered sequence of data based on the alignment matrix when the convergence condition is met.

An apparatus, system, and method for dynamic time warping are described. Embodiments of the apparatus, system, and method are configured to a diffusion wavelet component configured to generate diffusion wavelet basis vectors at a plurality of scales, wherein each of the scales corresponds to a power of a diffusion operator, an embedding component configured to compute a first embedding of a first ordered sequence of data and a second embedding of a second ordered sequence of data based on the diffusion wavelet basis vectors, and a warping component configured to generate alignment data for the first ordered sequence of data and the second ordered sequence of data by performing dynamic time warping based on the first embedding and the second embedding.

### BRIEF DESCRIPTION OF THE DRAWINGS

FIG. 1 shows an example of a system for dynamic time warping according to aspects of the present disclosure.

FIG. 2 shows an example of a dynamic time warping process according to aspects of the present disclosure.

FIG. 3 shows an example of a time-series alignment technique according to aspects of the present disclosure.

FIG. 4 shows an example of a process for dynamic time warping according to aspects of the present disclosure.

FIG. 5 shows an example of a process for generating diffusion wavelets according to aspects of the present disclosure.

FIG. 6 shows an example of diffusion wavelet construction according to aspects of the present disclosure.

FIG. 7 shows an example of diffusion operator levels according to aspects of the present disclosure.

FIG. 8 shows an example of dimensional embedding determination according to aspects of the present disclosure.

FIG. 9 shows an example of multiscale manifold alignment (MMA) according to aspects of the present disclosure.

FIG. 10 shows an example of warping on wavelets (WOW) according to aspects of the present disclosure.

FIG. 11 shows an example of warping on mixed manifolds (WAMM) according to aspects of the present disclosure.

FIG. 12 shows an example of a process for dynamic time warping according to aspects of the present disclosure.

### DETAILED DESCRIPTION

The present disclosure provides systems and methods for generating alignment data for ordered data sequences. Data analytics applications may be used to discover useful relationships among different data sets. For example, time-series data includes successive elements of a sequence that correspond to data captured at different times. Alignment of ordered sequences (e.g., alignment of two time series datasets) is used in a variety of applications including bioinformatics, activity recognition, human motion recognition, handwriting recognition, human-robot coordination, temporal segmentation, modeling the spread of disease, financial arbitrage, and building view-invariant representations of activities, among other examples.

Conventional data analytics applications use a variety of techniques to align ordered sequences such as time-series data. For instance, these applications may use Dynamic Time Warping (DTW) to generate an inter-set distance function. However, while conventional DTW techniques may be mathematically sound, the computational resources required to perform them may grow exponentially with the dimensionality of the data. As a result, conventional data analytics applications that utilize alignment algorithms such as DTW may fail on high-dimensional real-world data, or data where the dimensions of aligned sequences are not equal.

Applications that utilize conventional DTW may also fail under arbitrary affine transformations of one or both inputs. For example, some data analytics applications use canonical time warping (CTW), which combines DTW with canonical correlation analysis (CCA) to find a joint lower-dimensional embedding of two time-series datasets, and subsequently align the datasets in the lower-dimensional space. However, these applications may fail when the two related data sets use nonlinear transformations. Alternatively, manifold warping may be used by representing features in the latent joint manifold space of the sequences. However, existing methods may not provide accurate results for data that includes multiscale features because they do not take into account the multiscale nature of the data.

Therefore, the present disclosure provides systems and methods for aligning datasets using diffusion wavelets to embed the data into a multiscale manifold. Embodiments of the present disclosure include an improved data analytics application capable of performing DTW on high-dimensional data and multiscale feature data. For example, a data analytics application, according to the present disclosure, may use techniques that take into account the multiscale latent structure of real-world data, which may influence (e.g., improve) alignment of time-series datasets. Certain embodiments leverage the multiscale nature of datasets and provide a variant of dynamic time warping using a type of multiscale wavelet analysis on graphs, called diffusion wavelets.

Certain embodiments of the present disclosure utilize a method called Warping on Wavelets (WOW). The described techniques provide for a multiscale variant of manifold warping (e.g., WOW includes techniques that may be used to integrate DTW with a multi-scale manifold learning method called Diffusion Wavelets). Accordingly, the described WOW techniques may outperform other techniques (e.g., such as CTW and manifold warping) using real-world datasets. For instance, the techniques described herein provide a multiscale manifold method used to align high dimensional time-series data.

### System Overview

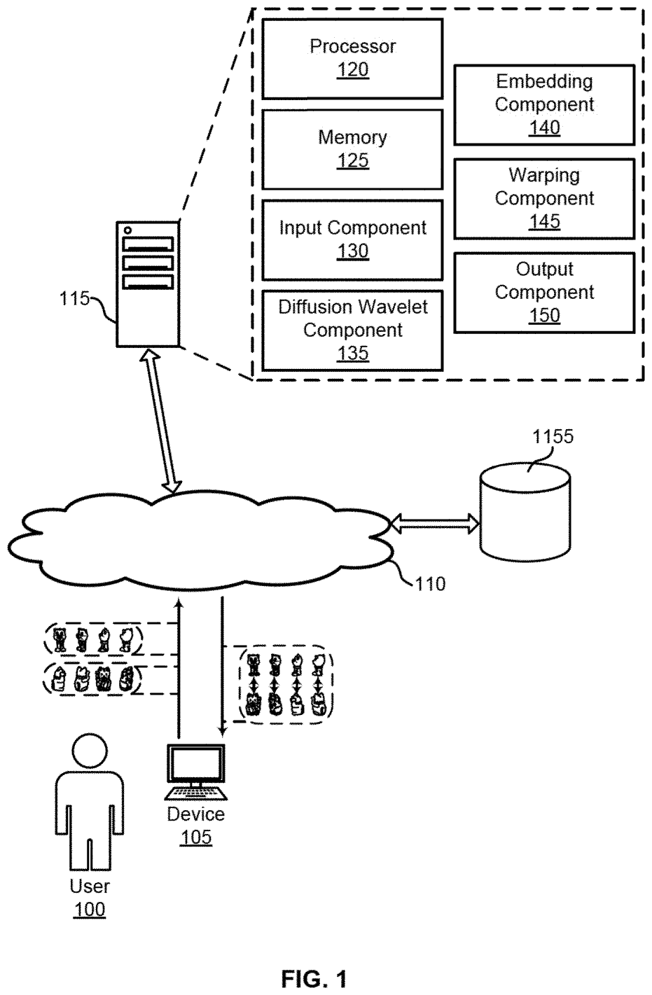

FIG. 1 shows an example of a system for dynamic time warping according to aspects of the present disclosure. The example shown includes user 100, device 105, cloud 110, server 115, and database 155. In one embodiment, the server 115 implements a data analytics application capable of performing DTW on high dimensional datasets. Thus the server 115 may include processor 120, memory 125, input component 130, diffusion wavelet component 135, embedding component 140, warping component 145, and output component 150. These components of server 115 may be implemented as software components or as hardwired circuits of the server 115. In another embodiment, a data analytics application may be implemented on the local device 105.

A user 100 may interface with a device 105 via a user interface. In some embodiments, the user interface may include an audio device, such as an external speaker system, an external display device such as a display screen, or an input device (e.g., remote control device interfaced with the user interface directly or through an input/output (I/O) controller module). In some cases, a user interface may be a graphical user interface (GUI).

A device 105 may include a computing device such as a personal computer, laptop computer, mobile device, mainframe computer, palmtop computer, personal assistant, or any other suitable processing apparatus. In some cases, device 105 may implement software. Software may include code to implement aspects of the present disclosure and may be stored in a non-transitory computer-readable medium such as system memory or other memory. In some cases, the software may not be directly executable by a processor but may cause a computer (e.g., when compiled and executed) to perform functions described herein.

A database 155 is an organized collection of data. For example, a database 155 stores data in a specified format known as a schema. A database 155 may be structured as a single database, a distributed database, multiple distributed databases, or an emergency backup database. In some cases, a database controller may manage data storage and processing in a database 155. In some cases, a user 100 interacts with database 155 via a database controller. In other cases, a database controller may operate automatically without user 100 interaction. In some examples, the user 100 may access multiple ordered sequences of data from the database 155, and may generate an alignment between the ordered sequences of data.

A processor 120 is an intelligent hardware device 105, (e.g., a general-purpose processing component, a digital signal processor (DSP), a central processing unit (CPU), a graphics processing unit (GPU), a microcontroller, an application-specific integrated circuit (ASIC), a field-programmable gate array (FPGA), a programmable logic device 105, a discrete gate or transistor logic component, a discrete hardware component, or any combination thereof). In some cases, the processor 120 is configured to operate a memory 125 array using a memory controller. In other cases, a memory controller is integrated into the processor 120. In some cases, the processor 120 is configured to execute computer-readable instructions stored in a memory 125 to perform various functions. In some embodiments, a processor 120 includes special-purpose components for modem processing, baseband processing, digital signal processing, or transmission processing.

Examples of a memory 125 include random access memory (RAM), read-only memory (ROM), or a hard disk. Examples of memory devices include solid-state memory and a hard disk drive. In some examples, memory 125 is used to store computer-readable, computer-executable software with instructions that, when executed, cause a processor 120 to perform various functions described herein. In some cases, the memory 125 contains, among other things, a basic input/output system (BIOS) which controls basic hardware or software operation such as the interaction with peripheral components or devices (e.g., such as device 105). In some cases, a memory controller operates memory cells. For example, the memory controller can include a row decoder, column decoder, or both. In some cases, memory cells within a memory 125 store information in the form of a logical state.

According to some embodiments, input component 130 receives a first ordered sequence of data and a second ordered sequence of data. For example, a user 100 may identify two videos to be aligned, where the ordered sequences of data are the ordered video frames. In another example, the ordered sequences are time series data. For example, the time series data may include economic data, weather data, consumption patterns, user interaction data, or any other sequences that may be ordered and aligned.

The user 100 may provide the ordered sequences to the input component 130 using a graphical user interface. In some examples, the first ordered sequence of data and the second ordered sequence of data each include time-series data. In some examples, the first ordered sequence of data and the second ordered sequence of data each include an ordered sequence of images.

According to some embodiments, diffusion wavelet component 135 generates diffusion wavelet basis vectors at multiple scales, where each of the scales corresponds to a power of a diffusion operator. In some examples, diffusion wavelet component 135 identifies the diffusion operator based on a Laplacian matrix. In some examples, diffusion wavelet component 135 computes a set of dyadic powers of the diffusion operator. In some examples, diffusion wavelet component 135 generates an approximate QR decomposition for each of the dyadic powers of the diffusion operator, where the diffusion wavelet basis vectors are generated based on the approximate QR decomposition. In some examples, the diffusion wavelet basis vectors include component vectors of diffusion scaling functions corresponding to the set of scales. According to some embodiments, diffusion wavelet component 135 identifies a number of nearest neighbors for the diffusion operator. For example, the diffusion wavelet basis vectors may be determined based on the number of nearest neighbors.

In some examples, the diffusion wavelet basis vectors are generated using a cost function based on multiscale Laplacian eigenmaps (MLE). In some examples, the diffusion wavelet basis vectors are generated using a cost function based on multiscale locality preserving projection (LPP). In some examples, the diffusion wavelet basis vectors are generated based on a QR decomposition of the dyadic powers of the diffusion operator.

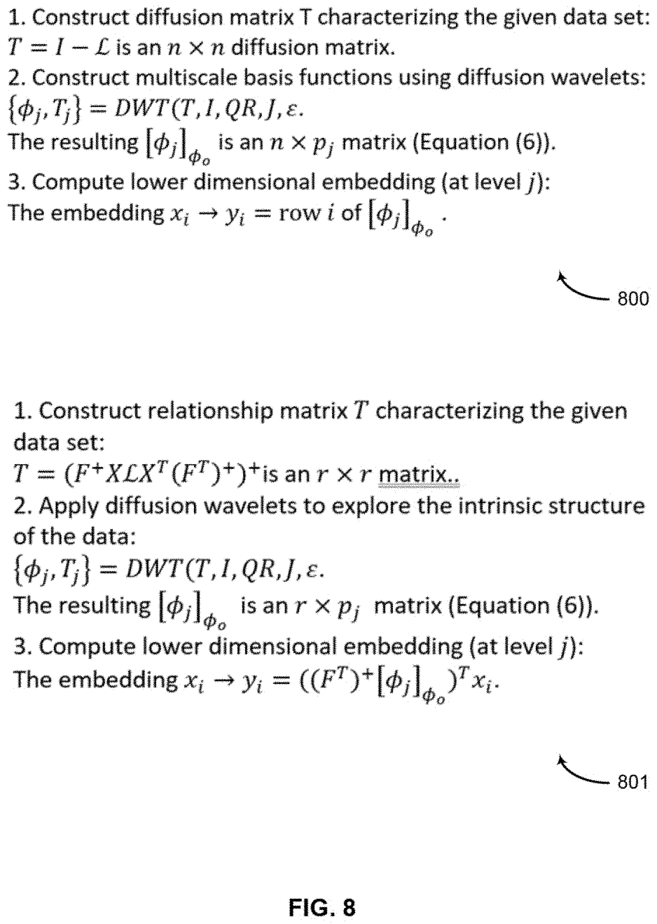

According to some embodiments, embedding component 140 computes a first embedding of the first ordered sequence of data and a second embedding of the second ordered sequence of data based on the diffusion wavelet basis vectors. In some examples, embedding component 140 computes a cost function based on MLE (e.g., as further described herein, for example, with reference to multiscale Laplacian Eigenmap embedding 800 of FIG. 8), where the first embedding and the second embedding are computed based on the cost function. In some examples, embedding component 140 computes a cost function based on a multiscale LPP (e.g., as further described herein, for example, with reference to multiscale LPP embedding 805 of FIG. 8), where the first embedding and the second embedding are computed based on the cost function. In some examples, the first embedding and the second embedding are based on a mixed manifold embedding objective function. In some examples, the first embedding and the second embedding are based on a curve wrapping loss function.

In some examples, embedding component 140 updates the first embedding, the second embedding, and the alignment matrix in a loop until a convergence condition is met. In some examples, embedding component 140 identifies a dimension of a latent space, where the first embedding and the second embedding include embeddings in the latent space. In some examples, embedding component 140 identifies a low-rank embedding hyper-parameter, where the first embedding and the second embedding are based on the low-rank embedding hyper-parameter. In some examples, embedding component 140 identifies a geometry correspondence hyper-parameter, where the first embedding and the second embedding are based on the geometry correspondence hyper-parameter.

According to some embodiments, embedding component 140 may be configured to compute a first embedding of a first ordered sequence of data and a second embedding of a second ordered sequence of data based on the diffusion wavelet basis vectors. In some examples, the first embedding, the second embedding, and an alignment matrix that identifies the alignment are iteratively computed until a convergence condition is met.

According to some embodiments, warping component 145 generates alignment data for the first ordered sequence of data and the second ordered sequence of data by performing dynamic time warping based on the first embedding and the second embedding. In some examples, warping component 145 computes a WOW loss function, where the alignment data is generated based on the WOW loss function. According to some embodiments, warping component 145 computes an alignment matrix identifying an alignment between the first ordered sequence of data and the second ordered sequence of data. In some examples, warping component 145 generates alignment data for the first ordered sequence of data and the second ordered sequence of data based on the alignment matrix when the convergence condition is met. According to some embodiments, warping component 145 may be configured to generate alignment data for the first ordered sequence of data and the second ordered sequence of data by performing dynamic time warping based on the first embedding and the second embedding.

According to some embodiments, output component 150 transmits the alignment data in response to receiving the first ordered sequence of data and the second ordered sequence of data.

In some examples, one or more aspects of the embedding, warping, or both may be performed using an artificial neural network (ANN). An ANN is a hardware or a software component with a number of connected nodes (i.e., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of the node's inputs. Each node and edge may be associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes may have a threshold below which a signal may not be transmitted. In some examples, the nodes are aggregated into layers. Different layers perform different transformations on the different layer's inputs. The initial layer is known as the input layer, and the last layer is known as the output layer. In some cases, signals traverse certain layers multiple times.

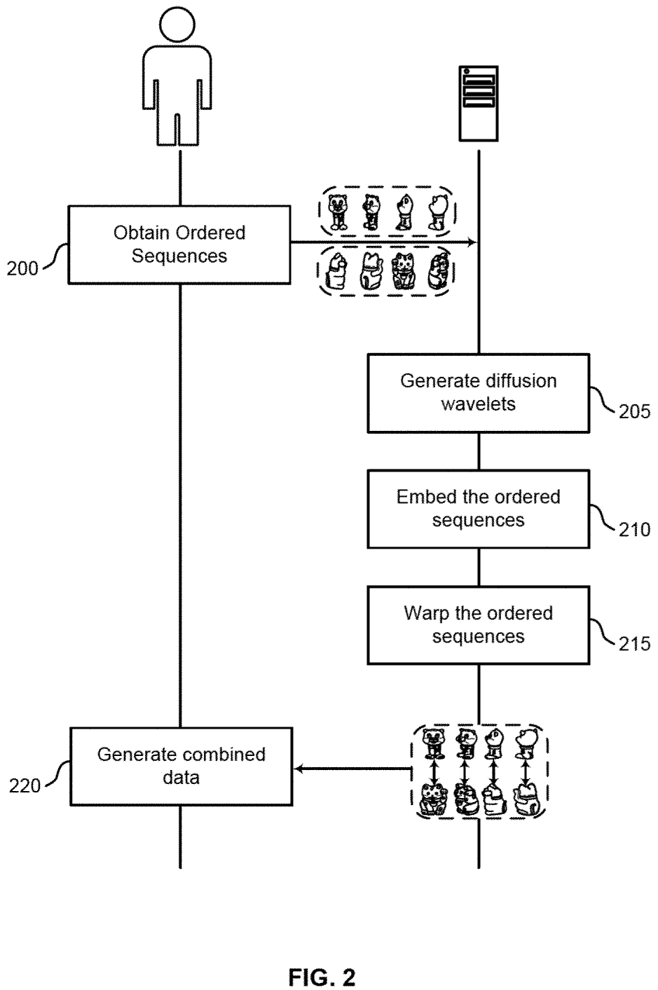

FIG. 2 shows an example of a dynamic time warping process according to aspects of the present disclosure. In some examples, these operations are performed by a system with a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

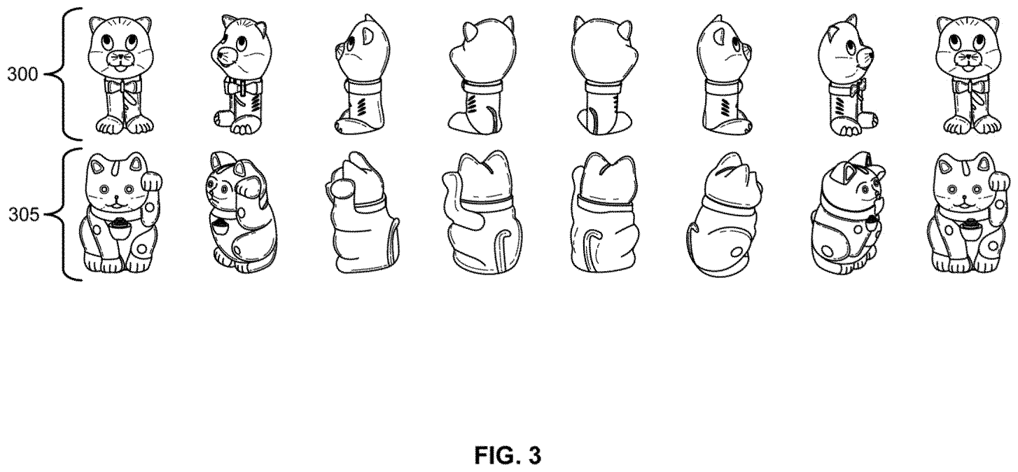

At operation 200, the system obtains multiple ordered sequences. In some cases, the operations of this step refer to, or may be performed by, a user as described with reference to FIG. 1. In some examples, ordered sequences are obtained from various sensors such as image sensors, accelerometers, gyroscopes, heat sensors, and pressure sensors, among various other examples. In some examples, ordered sequences are obtained from datasets such as the Columbia Object Image Library (COIL100 or COIL), a human activity recognition (HAR) dataset, a Carnegie Mellon University (CMU) Quality of Life dataset, and New York Stock Exchange (NYSE) datasets, among various other examples (e.g., as described in more detail herein, for example, with reference to FIG. 3).

In some examples, a user 100 may identify two videos to be aligned, where the ordered sequences of data are the ordered video frames. In another example, the ordered sequences are time series data. For example, the time series data may include economic data, weather data, consumption patterns, user interaction data, or any other sequences that may be ordered and aligned. The user 100 may provide the ordered sequences to the input component 130 using a graphical user interface.

At operation 205, the system generates diffusion wavelets (e.g., diffusion wavelet basis vectors). In some cases, the operations of this step refer to, or may be performed by, a diffusion wavelet component as described with reference to FIG. 1. Diffusion wavelets may be generated (e.g., by a diffusion wavelet component) according to the techniques described in more detail herein, for example, with reference to FIGS. 1, 5, and 6.

At operation 210, the system embeds the ordered sequences based on the diffusion wavelets. In some cases, the operations of this step refer to, or may be performed by, an embedding component as described with reference to FIG. 1. Embedding of the ordered sequences may be performed (e.g., by an embedding component) according to the techniques described in more detail herein, for example, with reference to FIGS. 1 and 8.

At operation 215, the system aligns (i.e., warps) the ordered sequences based on the embedding. In some cases, the operations of this step refer to, or may be performed by, a warping component as described with reference to FIG. 1. Warping of the embedded ordered sequences may be performed (e.g., by a warping component) according to the techniques described in more detail herein, for example, with reference to FIGS. 1 and 9-11)

At operation 220, the system generates combined data based on the warping. In some cases, the operations of this step refer to, or may be performed by, a user as described with reference to FIG. 1.

### Ordered Sequence Alignment

FIG. 3 shows an example of a time-series alignment technique according to aspects of the present disclosure. The example shown includes first ordered sequence of data 300 and second ordered sequence of data 305. In some cases, the first ordered sequence of data 300 and the second ordered sequence of data 305 may be referred to as time-series datasets. FIG. 3 may illustrate one or more aspects of a time-series alignment example involving rotating objects.

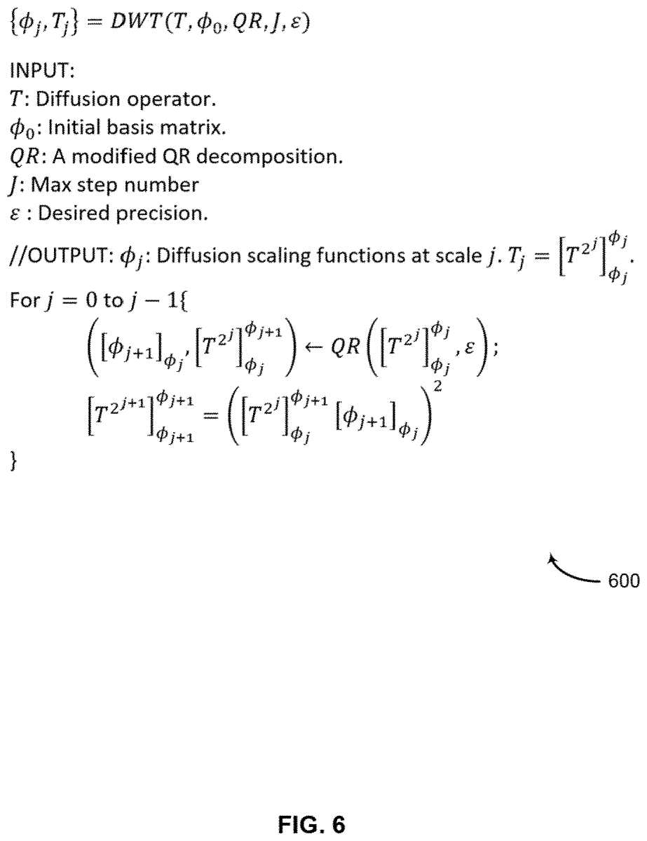

The first ordered sequence of data 300 and second ordered sequence of data 305 may be aligned according to the techniques described herein (e.g., according to WOW techniques described in more detail herein, for example, with reference to FIGS. 6 and 8-11). In some cases, the first ordered sequence of data 300 and the second ordered sequence of data 305 may be aligned using different techniques to compare error alignment. For instance, the COIL corpus provides a series of images taken at different objects on a rotating platform at different angles (e.g., first ordered sequence of data 300 may include a first series of images taken of a first object on a rotating platform at different angles and second ordered sequence of data 305 may include a second series of images taken of a second object on a rotating platform at different angles). In some examples, each series has 72 images and each image has 128×128 pixels.

In addition to COIL, other datasets may be used to analyze the performance of WOW techniques described herein (e.g., relative to WAMM, CW, two-step CW, manifold warping, etc.). For instance, a HAR dataset and a CMU Quality of Life dataset may be employed for performance/error analysis. A HAR dataset involves recognition of human activities from recordings made on a mobile device. Thirty volunteers performed six activities (WALKING, WALKING UPSTAIRS, WALKING DOWNSTAIRS, SITTING, STANDING, LAYING) while wearing a device (e.g., a smartphone) on the waist. 3-axial linear acceleration and 3-axial angular velocity measurements were captured at a constant rate of 50 Hz using an embedded accelerometer and gyroscope. A data set from the CMU Quality of Life Grand Challenge may include recorded human subjects cooking a variety of dishes. The original video frames are national television system committee (NTSC) quality (e.g., 680×480), which are subsampled to 60×80. Randomly chosen sequences of 100 frames may be analyzed at various points in two subjects' activities, where the two subjects are both making brownies.

For such performance/error analyses (e.g., for comparing performance/error of time series alignment of COIL, HAR dataset, CMY Quality of Life dataset, or other datasets amongst using techniques such as WOW, WAMM, CW, two-step CW, manifold warping, etc.), alignment error may be defined as follows. Let p*=[(1,1), . . . , (n, n)] be the alignment, and let p=[p1, . . . , pᵢ] be the alignment output by a particular algorithm. The error (p, p*) between p and p* is computed by the normalized difference in an area under the curve x=y (corresponding to p*) and the piecewise linear curve obtained by connecting points in p. The error (p, p*) between p and p* may have the property that p≠p*⇒error(p, p*)≠0.

In some examples, using a WOW technique results in reduced mean alignment errors when performing such error analysis using real-world data sets such as COIL, a HAR dataset, a CMU Quality of Life dataset, etc. As an example, comparing the WOW algorithm against the curve warping, as well as with two varieties of manifold warping, results may be averaged over 100 trials, where each trial uses a subject and activity at random, and 3-D accelerometer readings may be aligned with the gyroscope readings (e.g., and a paired T-test shows differences between WOW and other techniques are statistically significant).

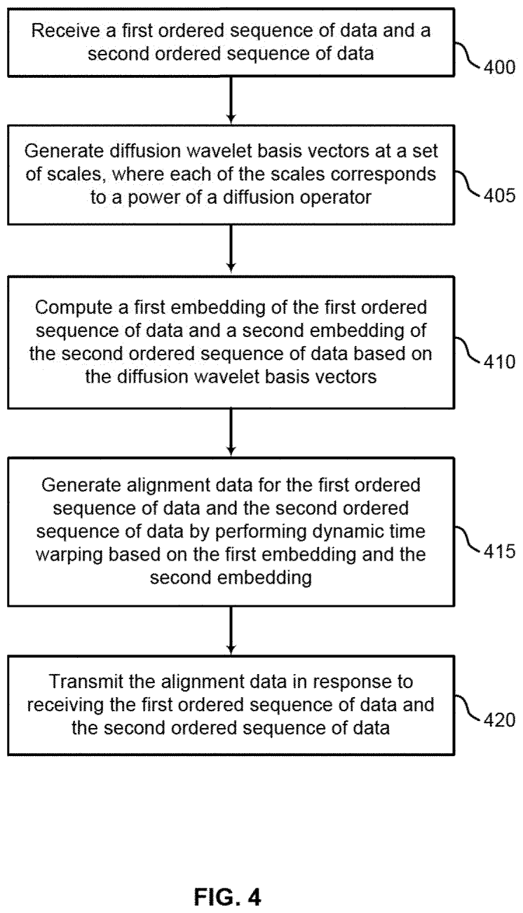

FIG. 4 shows an example of a process for dynamic time warping according to aspects of the present disclosure. In some examples, these operations are performed by a system with a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 400, the system receives a first ordered sequence of data and a second ordered sequence of data. In some cases, the operations of this step refer to, or may be performed by, an input component as described with reference to FIG. 1.

At operation 405, the system generates diffusion wavelet basis vectors at a set of scales, where each of the scales corresponds to a power of a diffusion operator. In some cases, the operations of this step refer to, or may be performed by, a diffusion wavelet component as described with reference to FIG. 1. Diffusion wavelet basis vectors may be generated (e.g., by a diffusion wavelet component) according to the techniques described in more detail herein, for example, with reference to FIGS. 1, 5, and 6.

At operation 410, the system computes a first embedding of the first ordered sequence of data and a second embedding of the second ordered sequence of data based on the diffusion wavelet basis vectors. In some cases, the operations of this step refer to, or may be performed by, an embedding component as described with reference to FIG. 1.

At operation 415, the system generates alignment data for the first ordered sequence of data and the second ordered sequence of data by performing dynamic time warping based on the first embedding and the second embedding. In some cases, the operations of this step refer to, or may be performed by, a warping component as described with reference to FIG. 1.

At operation 420, the system transmits the alignment data in response to receiving the first ordered sequence of data and the second ordered sequence of data. In some cases, the operations of this step refer to, or may be performed by, an output component as described with reference to FIG. 1.

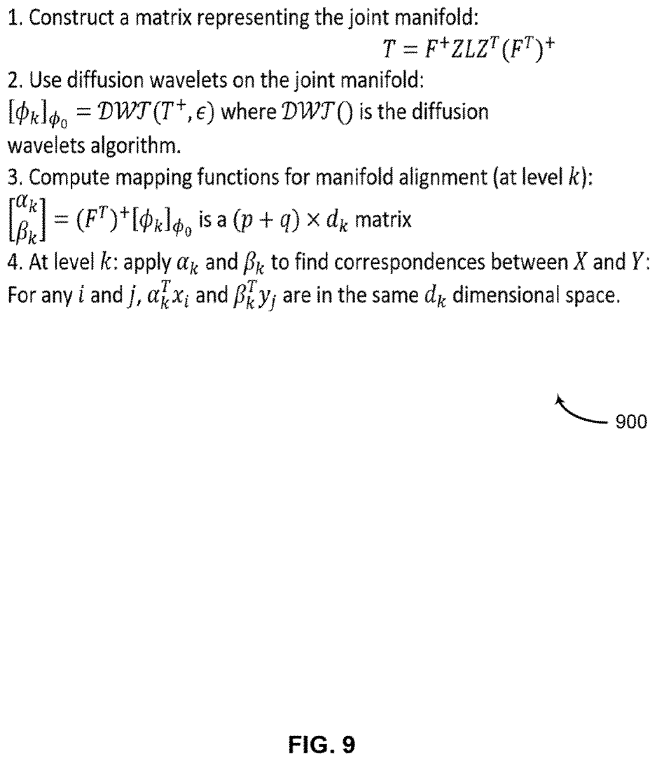

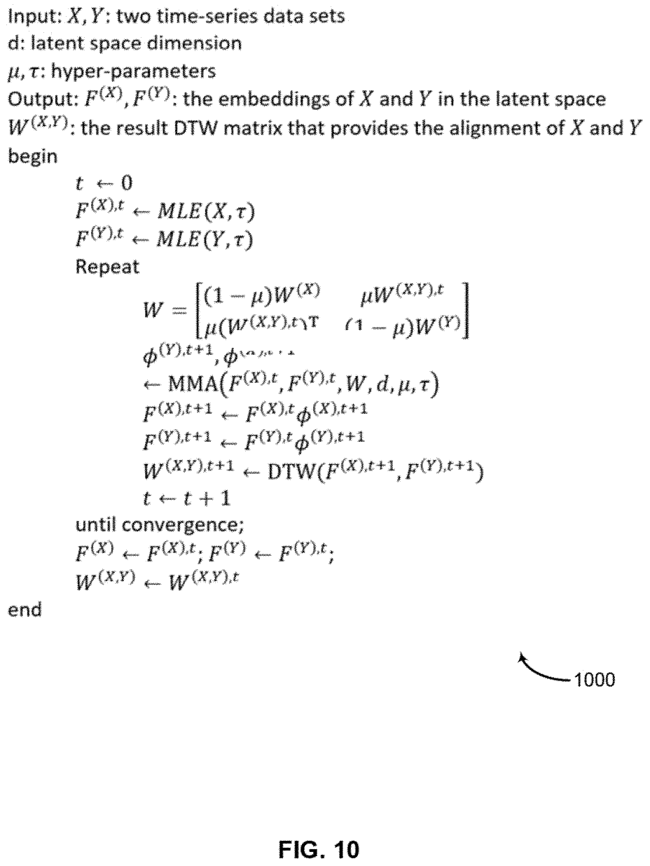

In some examples, operation 410 and operation 415 may be performed iteratively. For instance, embedding (e.g., computation of a first embedding of the first ordered sequence of data and a second embedding of the second ordered sequence of data) and alignment (e.g., generation of alignment data for the first ordered sequence of data and the second ordered sequence of data) may be performed iteratively as further described herein (e.g., techniques described with reference to FIGS. 9 and 10 may be performed iteratively).

### Diffusion Wavelets

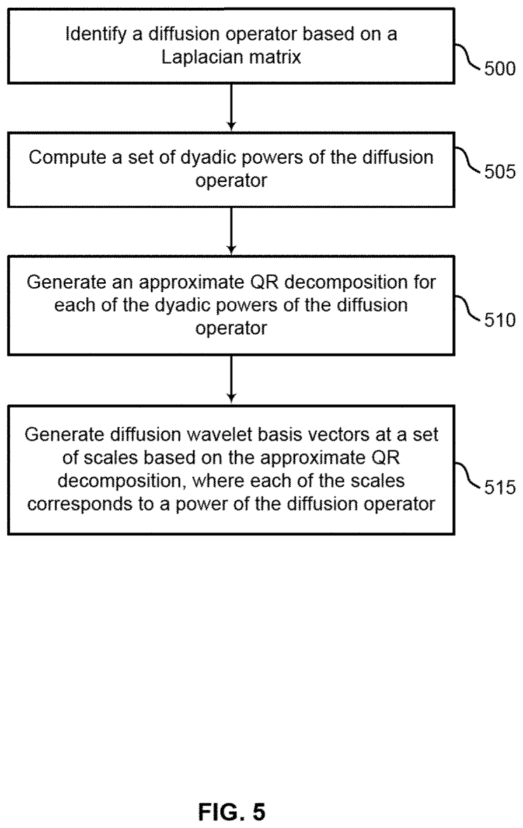

FIG. 5 shows an example of a process for generating diffusion wavelets (e.g., a process for constructing diffusion wavelet basis vectors) according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations. The process for generating diffusion wavelets shown in FIG. 5 is described in more detail herein, for example, with reference to FIG. 6.

At operation 500, the system identifies a diffusion operator based on a Laplacian matrix. In some cases, the operations of this step refer to, or may be performed by, a diffusion wavelet component as described with reference to FIG. 1.

At operation 505, the system computes a set of dyadic powers of the diffusion operator. In some cases, the operations of this step refer to, or may be performed by, a diffusion wavelet component as described with reference to FIG. 1.

At operation 510, the system generates an approximate QR decomposition for each of the dyadic powers of the diffusion operator. In some cases, the operations of this step refer to, or may be performed by, a diffusion wavelet component as described with reference to FIG. 1.

At operation 515, the system generates diffusion wavelet basis vectors at a set of scales based on the approximate QR decomposition, where each of the scales corresponds to a power of the diffusion operator. In some cases, the operations of this step refer to, or may be performed by, a diffusion wavelet component as described with reference to FIG. 1.

FIG. 6 shows an example of diffusion wavelet construction according to aspects of the present disclosure. For instance, example diffusion wavelet construction 600 may show an example diffusion wavelet function (e.g., {ϕⱼ, Tⱼ}=DWT(T, ϕ₀, QR, J, ε)), example input to the diffusion wavelet function (e.g., T, ϕ₀, QR, J, ε), and example output from the diffusion wavelet function (e.g., ϕⱼ).

For example, sequential data sets X=[x₁^{T}, . . . , xₙ^{T}]^{T} ∈ [symbol] ^{n×d} Y=[y₁^{T}, . . . , yₘ^{T}]^{T} ∈ [symbol] ^{m×d} are provided in the same space with a distance function dist: X×Y→ [symbol] . Let P={p₁, . . . , pₛ} represent an alignment between X and Y, where each pₖ=(i,j) is a pair of indices such that xᵢ corresponds with yⱼ. In some embodiments, sequential data sets X and Y may be referred to as a first ordered sequence of data and a second ordered sequence of data. Since the alignment may be directed to sequentially-ordered data, additional constraints may be used below:

p₁=(1,1) (1)

pₛ=(n,m) (2)

pₖ₊₁−pₖ=(1,0) or (0,1) or (1,1) (3)

A valid alignment may match the first and/or last instances and may not skip any intermediate instance. Additionally or alternatively, no two subalignments cross each other. The alignment may be represented in matrix form W where:

$${W}_{i , j} = \{ \begin{matrix}1 & if ( i , j ) ∈ P \\ 0 & otherwise\end{matrix} \qquad ( 4 )$$

For W to represent an alignment which satisfies Equations 1, 2, 3; matrix W may be in the following form: W_{1,1}=1, W_{n,m}=1. In some cases, none of the columns or rows of matrix W may be a 0 vector. Additionally or alternatively, there may not be any 0's between any two 1's in a row or column of matrix W. In some examples, a matrix W using these conditions may be referred to as a DTW matrix. An alignment may minimize the loss function with respect to the DTW matrix W:

L_{DTW}(W)=Σ_{i,j} dist(xᵢ,yⱼ)W_{i,j} (5)

A naive search over the valid alignments takes time. However, dynamic programming can produce an alignment in O(nm). When m is highly dimensional, or if the two sequences have varying dimensionality, a broader method may be used to extend DTW based on the manifold nature of many real-world datasets.

Example diffusion wavelet construction 600 shows diffusion wavelets construct multiscale representations at different scales. The notation [T]_{ϕ}_{ₐ}^{ϕ}^{_{b}} denotes matrix T whose column space is represented using basis ϕ_{b} at scale b, and row space is represented using basis ϕₐ at scale a. The notation [ϕ_{b}]_{ϕ}_{ₐ} denotes basis ϕ_{b} represented on the basis ϕₐ. At an arbitrary scale j, pⱼ basis functions may be used, and a length of each function is lⱼ. [T]_{ϕ}_{ₐ}^{ϕ}^{_{b}} is a p_{b}×lₐ matrix and [ϕ_{b}]_{ϕ}_{ₐ} is an lₐ×p_{b} matrix.

For instance, for multiscale manifold learning, diffusion wavelets use embodiments of classical wavelets for data in graphs and manifolds. The term diffusion wavelets may be used because diffusion wavelets may be associated with a diffusion process defining different scales, providing a multiscale analysis of functions on manifolds and graphs. FIG. 6 may illustrate an example where an input matrix T is orthogonalized using an approximate QR decomposition in the first step. T's QR decomposition is written as T=QR, where Q is an orthogonal matrix, and R is an upper triangular matrix. The orthogonal columns of Q are the scaling functions and span the column space of matrix T. The upper triangular matrix R is the representation of T on the basis Q. In the second step, T² is determined. In some cases, T² may not be determined by multiplying T by itself. For instance, T² is represented on the new basis Q: T²=(RQ)². Since Q may have fewer columns than T, due to the approximate QR decomposition, T² may be a smaller square matrix. The above process is repeated at the next level, generating compressed dyadic powers T²^{^{j}}, until a predetermined threshold is reached (e.g., until a maximum level is reached), or until its effective size is a 1×1 matrix. Small powers of T may correspond to short-term behavior in the diffusion process and large powers or T may correspond to long-term behavior.

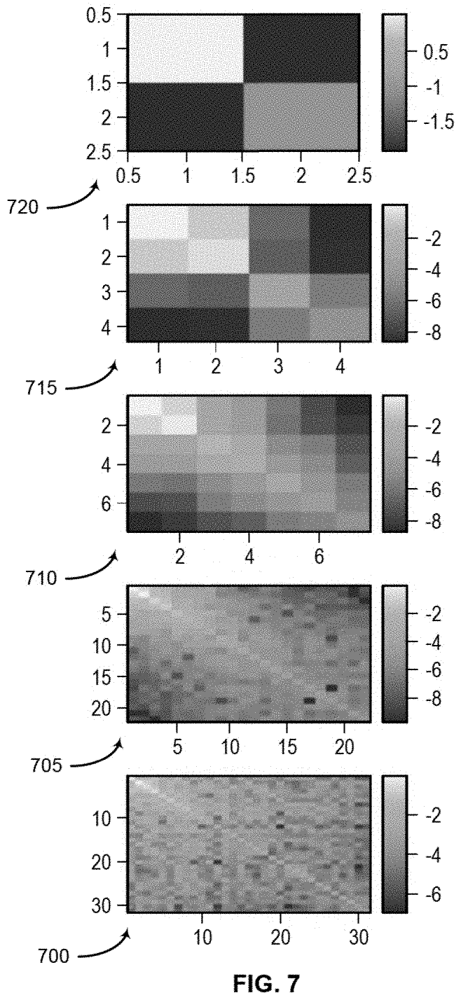

FIG. 7 shows an example of diffusion operator levels according to aspects of the present disclosure. For example, diffusion bases 700-720 may illustrate how a QR decomposition is used to obtain a higher ordered representation of a diffusion operator. Diffusion operator level 700 may illustrate a low-level diffusion operator of high dimensionality (e.g., data with a lot of matrix elements). Using QR decomposition, a diffusion operator may be represented through diffusion basis 705, diffusion basis 710, diffusion basis 715, and then diffusion basis 720. Diffusion basis 720 may illustrate a high ordered representation of a diffusion operator (e.g., a simpler diffusion operator matrix with lower dimensionality data). In some aspects, diffusion bases 700-720 may illustrate different levels of ϕⱼ as described herein (e.g., with reference to FIG. 6). In some examples, diffusion basis 700 may illustrate aspects of ϕⱼ for j=0 and diffusion bases 705-720 may illustrate aspects of ϕᵢ for j>0.

### Multiscale Manifold Embedding

FIG. 8 shows an example of dimensional embedding determination according to aspects of the present disclosure. The example shown includes multiscale Laplacian Eigenmap embedding 800 and multiscale LPP embedding 805. In some examples, the operations of FIG. 8 are performed by an embedding component 140, which may be implemented as a software component, or as a hardware circuit.

For instance, embodiments of the present disclosure use multiscale extensions of Laplacian eigenmaps and LPP. Multiscale Laplacian Eigenmap embedding 800 constructs embeddings of data using the low-order eigenvectors of the graph Laplacian as a new coordinate basis, which extends Fourier analysis to graphs and manifolds. Multiscale LPP embedding 805 is a linear approximation of Laplacian eigenmaps. In some examples, the multiscale Laplacian eigenmaps and multiscale LPP are reviewed based on the diffusion wavelets method.

Notation: X=[x₁, . . . , xₙ] may be a p×n matrix representing n instances defined in a p dimensional space. W is an n×n weight matrix, where W_{i,j} represents the similarity of xᵢ and xⱼ. Additionally or alternatively, W_{i,j} can be defined by e^{-∥x}^{ᵢ}^{x}^{ⱼ}^{∥}^{²}. D is a diagonal valency matrix, where D_{i,i}ΣⱼW_{i,j}. W=D^{-0.5} WD^{-0.5}. [symbol] =I−W, where [symbol] is the normalized Laplacian matrix and I is an identity matrix. XX^{T}=FF^{T}, where F is a p×r matrix of rank r. Singular value decomposition may be used to compute F from X. (⋅)⁺ represents the Moore-Penrose pseudo inverse.

Laplacian eigenmaps minimize the cost function Σ_{i,j}(yᵢ−yⱼ)² W_{i,j}, which encourages the neighbors in the original space to be neighbors in the new space. The c dimensional embedding is provided by eigenvectors of [symbol] x=λx corresponding to the c smallest non-zero eigenvalues. The cost function for multiscale Laplacian eigenmaps is defined as follows: given X, compute Yₖ=[yₖ¹, . . . , yₖⁿ] at level k (Yₖ is a pₖ×n matrix) to minimize Σ_{i,j}(yₖⁱ−yₖ^{j})² W_{i,j}. Here k=1, . . . , J represents each level of the underlying manifold hierarchy.

LPP is a linear approximation of Laplacian eigenmaps. LPP minimizes the cost function Σ_{i,j}(ƒ^{T}xᵢ−ƒ^{T}xⱼ)² W_{i,j}, where mapping function ƒ constructs a c dimensional embedding. Additionally or alternatively, the mapping function ƒ is defined by the eigenvectors of X [symbol] X^{T}x=λXX^{T}x corresponding to the c smallest non-zero eigenvalues. Similar to multiscale Laplacian eigenmaps, multiscale LPP learns linear mapping functions defined at multiple scales to achieve multilevel decompositions.

Multiscale Laplacian eigenmaps (e.g., multiscale Laplacian Eigenmap embedding 800) and multiscale LPP algorithms (e.g., multiscale LPP embedding 805) are shown in FIG. 8, where

$${[ {ϕ}_{j} ]}_{{ϕ}_{0}}$$

is used to compute a lower dimensional embedding. As shown in FIG. 6, the scaling functions

$${[ {ϕ}_{j + 1} ]}_{{ϕ}_{j}}$$

are the orthonormal bases that span the column space of T at different levels. The scaling functions define a set of new coordinate systems with information in the original system at different scales. The scaling functions also provide a mapping between the data at longer spatial and or temporal scales and smaller scales. The basis functions at level j can be represented in terms of the basis functions at the next lower level using the scaling functions. As a result, the extended basis functions can be expressed in terms of the basis functions at the finest scale using:

$${[ {ϕ}_{j} ]}_{{ϕ}_{0}} = {{[ {ϕ}_{j} ]}_{{ϕ}_{j - 1}} [ {ϕ}_{j - 1} ]}_{{ϕ}_{0}} = {[ {ϕ}_{j} ]}_{{ϕ}_{j - 1}} . . . {{[ {ϕ}_{1} ]}_{{ϕ}_{0}} [ {ϕ}_{0} ]}_{{ϕ}_{0}} , \qquad ( 6 )$$

where each element on the right-hand side of Equation 6 is created by the procedure shown in FIG. 6. In the present disclosure,

$${[ {ϕ}_{j} ]}_{{ϕ}_{0}}$$

is used to compute lower dimensional embeddings at multiple scales. Given

$${[ {ϕ}_{j} ]}_{{ϕ}_{0}} ,$$

any vector/function on me compressed large scale space can be extended naturally to the finest scale space or vice versa. The embedding component 140 computes the connection between vector v at the finest scale space and a compressed representation at scale j. In some embodiments, the embedding component 140 utilizes the equation

$${[ v ]}_{{ϕ}_{0}} = {( {[ {ϕ}_{j} ]}_{{ϕ}_{0}} ) [ v ]}_{{ϕ}_{j}} . \qquad$$

The elements in [ϕⱼ]_{ϕ}_{₀} may be coarser or smoother than the initial elements in [ϕ₀]_{ϕ}_{₀}. Therefore, the elements in [ϕⱼ]_{ϕ}_{₀} can be represented in a compressed form.

FIG. 9 shows an example of MMA according to aspects of the present disclosure. For instance, example MMA 900 may show a method for transfer learning across two datasets. Data sets X and Y of shapes N_{X}×D_{X} and N_{Y}×D_{Y}, respectively, are used, where each row is a sample (or instance) and each column is a feature, and a correspondence matrix C^{(X,Y)} of shape N_{X}×N_{Y}, where

$${C}_{i , j}^{( X , Y )} = \{ \begin{matrix}\text{1:} & {X}_{i} is in correspondence with {Y}_{j} \\ \text{0:} & otherwise\end{matrix} \qquad ( 7 )$$

Manifold alignment calculates the embedded matrices F^{(X)} and F^{(Y)} of shapes N_{X}×d and N_{Y}×d for d≤min(D_{X},D_{Y}), where d≤min(D_{X},D_{Y}) are the embedded representation of X and Y in a shared, low-dimensional space. These embeddings aim to preserve both the intrinsic geometry within each data set and the sample correspondences among the data sets. More specifically, the embeddings minimize the following loss function:

$${L}_{M A} ( {F}^{( X )} , {F}^{( Y )} ) = \frac{μ}{2} {\sum }_{i = 1}^{{N}_{x}} {\sum }_{j = 1}^{{N}_{Y}} {‖ {F}_{i}^{( X )} - {F}_{j}^{( Y )} ‖}_{2}^{2} {C}_{i , j}^{( X , Y )} + \frac{1 - μ}{2} {\sum }_{i , j = 1}^{{N}_{x}} {‖ {F}_{i}^{( X )} - {F}_{j}^{( X )} ‖}_{2}^{2} {W}_{i , j}^{( X )} + \frac{1 - μ}{2} {\sum }_{i , j = 1}^{{N}_{y}} {‖ {F}_{i}^{( Y )} - {F}_{j}^{( Y )} ‖}_{2}^{2} {W}_{i , j}^{( Y )} \qquad ( 8 )$$

where N is the number of samples, N_{X}+N_{Y}, μ, ∈[0,1] is the correspondence tuning parameter, and W^{(x)}, W^{(Y)} are the calculated similarity matrices of shapes N_{X}×N_{X} and N_{Y}×N_{Y}, such that

$${W}_{i , j}^{( X )} = \{ \begin{matrix}k ( {X}_{i} , {X}_{j} \text{):} & {X}_{j} is a neighbor of {X}_{i} \\ \text{0:} & otherwise\end{matrix} \qquad ( 9 )$$

for a given kernel function k(⋅,⋅). W_{i,j}^{(Y)} is defined in the same fashion and k is set to be the nearest neighbor set member function or the heat kernel k(Xᵢ,Xⱼ)=exp(−|Xᵢ−Xⱼ²).

In the loss function of Equation 8, the first term corresponds to the alignment error between corresponding samples in different data sets. The second and third terms correspond to the local reconstruction error for the data sets X and Y respectively. Equation 8 can be simplified using block matrices by introducing a joint weight matrix W and a joint embedding matrix F, where

$$\begin{matrix}W = [ \begin{matrix}( 1 - μ ) {W}^{( X )} & μ {C}^{( X , Y )} \\ μ {C}^{( Y , X )} & ( 1 - μ ) {W}^{( Y )}\end{matrix} ] & ( 10 ) \\ and & \\ F = [ \begin{matrix}{F}^{( X )} \\ {F}^{( Y )}\end{matrix} ] & ( 11 )\end{matrix}$$

### Dynamic Time Warping

FIG. 10 shows an example of WOW according to aspects of the present disclosure. WOW 1000 may illustrate aspects of multiscale alignment. For example, given a fixed sequence of dimensions, d₁>d₂> . . . >dₕ, as well as two datasets, X and Y, and some partial correspondence information, xᵢ ∈Xₗ ↔yᵢ ∈Yₗ, the multiscale manifold alignment may be used to compute mapping functions, [symbol] ₖ and Bₖ, at each level k(k=1, 2, . . . , h) that project X and Y to a new space, preserving local geometry of each dataset and matching instances in correspondence. Furthermore, the associated sequence of mapping functions should satisfy span( [symbol] ₁)⊇pan( [symbol] ₂) . . . ⊇span( [symbol] ₕ) and span( [symbol] ₁)⊇pan( [symbol] ₂) . . . ⊇span( [symbol] ₕ), where span( [symbol] ᵢ) (or span( [symbol] ᵢ)) represents the subspace spanned by the columns of [symbol] ᵢ (or [symbol] ᵢ).

### Notation:

xᵢ ∈Rₚ; X={x₁, . . . , xₘ} is a p×m matrix;
Xₗ={x₁, . . . , xₗ} is a p×l matrix.
yᵢ∈R^{q}; Y={y₁, . . . ,yₙ} is a q×n matrix;
Yₗ={yₗ} is a q x/matrix.
Xₗ and Yₗ are in correspondence: xᵢ ∈Xₗ ↔H yᵢ ∈Yₗ.
Wₓ is a similarity matrix, e.g.

$${W}_{x}^{i , j} = {e}^{- \frac{{‖ {x}_{i} - {x}_{j} ‖}^{2}}{2 {σ}^{2}}}$$

Dx is a full rank diagonal matrix: Dₓ^{i,i}=ΣⱼWₓ^{i,j};
Lₓ=Dₓ−Wₓ is the combinatorial Laplacian matrix.
W_{y}, D_{y} and L_{y} are defined similarly.
Ω₁-Ω₄ are diagonal matrices with μ on the top l
Elements of the diagonal (the other elements are 0s);
Ω₁ is an m×m matrix; Ω₂ and Ω₃^{T} are m×n matrices;
Ω₄ is an n×n matrix.

$$Z = ( \begin{matrix}X & 0 \\ 0 & Y\end{matrix} ) is a ( p + q ) \times ( m + n ) matrix . \\ D = ( \begin{matrix}{D}_{x} & 0 \\ 0 & {D}_{y}\end{matrix} ) and L = ( \begin{matrix}{L}_{x} + {Ω}_{1} & - {Ω}_{2} \\ - {Ω}_{3} & {L}_{y} + {Ω}_{4}\end{matrix} )$$

are both (m+n)×(m+n) matrices.
F is a (p+q)×r matrix, where r is the rank of ZDZ^{T}
and FF^{T}=ZDZ^{T}. F can be constructed by SVD.
(⋅)⁺ represents the Moore-Penrose pseudoinverse.
At level k: αₖ is a mapping from x∈X to a point,
αₖ^{T} x, in a dₖ dimensional space (αₖ is a p×dₖ matrix).
At level k: βₖ is a mapping from y∈Y to a point,
βₖ^{T}y, in a dₖ dimensional space
(βₖ is a q×dk matrix).

To apply diffusion wavelets to multiscale alignment, the construction uses two input matrices A and B that occur in a generalized eigenvalue decomposition, A_{λ}=λB_{λ}. Given X, Xₗ, Y, Yₗ, using the notation defined above, the algorithm is shown in WOW 1000.

WOW 1000 may illustrate one or more aspects of multiscale dynamic time warping. WOW 1000 describes a multiscale diffusion-wavelet based method for aligning two sequentially-ordered data sets. MLE denotes the multi-scale Laplacian Eigenmaps algorithm (e.g., multiscale Laplacian Eigenmap embedding 800) described in FIG. 8. Additionally or alternatively, MMA denotes the multi-scale manifold alignment method provided by MMA 900. The loss function for WOW is reformulated as:

L_{WOW}(ϕ^{(X)},ϕ^{(Y)},W^{(X,Y)}=((1−μ)Σ_{i,j∈X}∥Fᵢ^{(X)}ϕ^{(X)}−Fⱼ^{(X)}ϕ^{(X)}∥²W_{i,j}^{(X)}+(1−μ)Σ_{i,j∈X}∥Fᵢ^{(Y)}ϕ^{(Y)}−Fj^{(Y)}ϕ^{(Y)}∥²W_{i,j}^{(Y)}+μΣ_{i∈X,j∈Y}∥Fᵢ^{(X)}ϕ^{(X)}−Fⱼ^{(Y)}ϕ^{(Y)}∥²W_{i,j}^{(X,Y)} (12)

which is the same loss function as in linear manifold alignment except that W(X;Y) is now a variable.

In an example scenario, let L_{WOW,t} be the loss function L_{WOW} evaluated at Πᵢ₌₁^{t} ϕ^{(X),i}, Πⁱ⁼¹^{t}ϕ^{(Y),i}, W^{(X,Y),t} of MMA 900. The sequence L_{WOW,t} converges to a minimum as t→∞. Therefore, MMA 900 terminates.

At any iteration t, WOW 1000 first fixes the correspondence matrix at W^{(X,Y),t}. Now let L_{WOW}′ equal L_{WOW} above, and replace Fᵢ^{(X)}, Fᵢ^{(Y)} by Fᵢ^{(X),t}, Fᵢ^{(Y),t} and MMA 900 minimizes L₄′ over ϕ^{(X),t+1}, ϕ^{(Y),t+1} using mixed manifold alignment. Therefore,

$$\begin{matrix}{L}_{WOW}^{′} ( {ϕ}^{( X ) , t + 1} , {ϕ}^{( Y ) , t + 1} , {W}^{( X , Y ) , t} ) \leq {L}_{WOW}^{′} ( I , I , {W}^{( X , Y ) , t} ) = {L}_{WOW} ( {Π}_{i = 1}^{t} {ϕ}^{( X ) , i} , {Π}_{i = 1}^{t} {ϕ}^{( Y ) , i} , {W}^{( X , Y ) , t} ) = {L}_{WOW , t} & ( 13 ) \\ since & \\ {F}^{( X ) , t} = {F}^{( X ) , 0} {Π}_{i = 1}^{t} {ϕ}^{( X ) , i} and {F}^{( Y ) , t} = {F}^{( Y ) , 0} {Π}_{i = 1}^{t} {ϕ}^{( X ) , i} . \\ Additionally , & \\ {L}_{WOW}^{′} ( {ϕ}^{( X ) , t + 1} , {ϕ}^{( Y ) , t + 1} , {W}^{( X , Y ) , t} ) = {L}_{WOW} ( {Π}_{i = 1}^{t + 1} {ϕ}^{( X ) , i} , {Π}_{i = 1}^{t + 1} {ϕ}^{( Y ) , i} , {W}^{( X , Y ) , t} ) \leq {L}_{WOW , t} & ( 14 )\end{matrix}$$

WOW 1000 then performs DTW to change W^{(X,Y),t} to W^{(X,Y),t+1}. Therefore,

L_{WOW}(Πᵢ₌₁^{t+1}ϕ^{(X),i},Πᵢ₌₁^{t+1}ϕ^{(Y),i},W^{(X,Y),t+1})≤L_{WOW}(Πᵢ₌₁^{t+1}ϕ^{(X),i},Πᵢ₌₁^{t+1}ϕ^{(Y),i},W^{(X,Y),t})≤L_{WOW,t}⇔L_{WOW,t+1}≤L_{WOW,t}. (15)

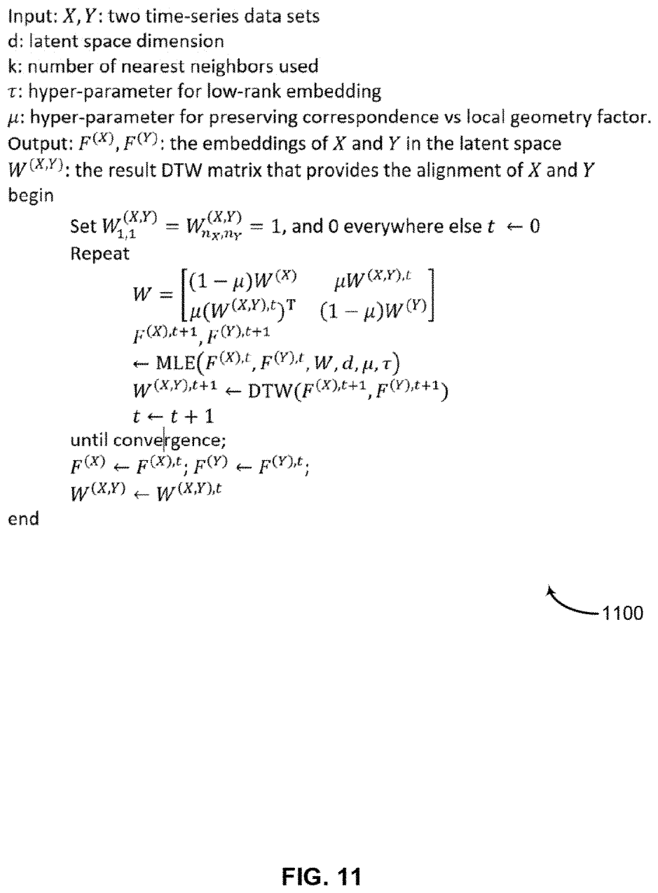

FIG. 11 shows an example of WAMM according to aspects of the present disclosure. The techniques described herein may provide variants of dynamic time warping called WAMM and curve warping. WAMM and curve wrapping are described in the following sections. In WAMM 1100, MLE(X, Y, W, d, μ) is a function that returns the embedding of X, Y in a d dimensional space using (mixed) manifold alignment with the joint similarity matrix W and parameter μ described in the previous sections. To construct such an embedding, the MME (for mixed-manifold) may be used for embedding objective function:

$${L}_{M L E} ( R , τ ) = {min}_{R} \frac{1}{2} \frac{τ}{2} {‖ X - X R ‖}_{F}^{2} + {‖ R ‖}_{*} , \qquad ( 16 )$$

where λ>0, ∥X∥_{F}=\sqrt{ΣᵢΣⱼ|x_{i·j}|²} is the Frobenius norm, and ∥X∥_{*}=Σᵢσᵢ (X) is the spectral norm, for singular values σᵢ.

The following shows how to minimize the objective function in Equation 16 using a SVD computation.

Let X=UΣV^{T} be the singular value decomposition of a data matrix X. Then, the solution to Equation 16 is given by

$$\hat{R} = {V}_{1} ( I - \frac{1}{τ} {Λ}_{1}^{- 2} ) {V}_{1}^{T} \qquad ( 17 )$$

where U=[U₁ U2], λ=diag(Λ₁Λ₂), and V=(V₁V₂) are partitioned according to the sets

$${I}_{1} = \{ {\text{i:λ}}_{i} > \frac{1}{\sqrt{τ}} \} , and {I}_{2} = \{ {\text{i:λ}}_{i} \leq \frac{1}{\sqrt{τ}} \} .$$

Curve wrapping is another variant that uses a Laplacian regularization. Since X and Y are points from a time series, xᵢ, xᵢ₊₁ may be to be close to each other for 1≤i≤n and yᵢ, yᵢ₊₁ to be close to each other for 1≤j<m: The loss function may be defined as

L_{CW}(F^{(X)},F^{(Y)},W^{(X,Y)})=((1−μ)Σᵢ₌₁ⁿ⁻¹∥Fᵢ^{(X)}-Fᵢ₊₁^{(X)}∥²W_{i,i+1}^{(X)}+(1−μ)Σᵢ₌₁ⁿ⁻¹∥Fᵢ^{(Y)}−Fᵢ₊₁^{(Y)}∥²W_{i,i+1}^{(Y)}+μΣ_{i∈X,j∈Y}∥Fᵢ^{(X)}−Fⱼ^{(Y)}∥²W_{i,j}^{(X,Y)} (18)

where W_{i,i+1}^{(X)}, W_{i,i+}^{(Y)}=1 may be equal to one or W_{i,i+1}^{(X)}=k^{X} (xᵢ, xᵢ₊₁), W_{i,i+1}^{(Y)}=k^{Y}(yᵢ, yᵢ₊₁) for some appropriate kernel functions k^{X}, k^{Y}. W may be defined by

$$W = [ \begin{matrix}( 1 - μ ) {W}^{X} & μ {W}^{( X , Y )} \\ {μ ( {W}^{( X , Y )} )}^{T} & ( 1 - μ ) {W}^{X}\end{matrix} ]$$

and let L_{W} be the Laplacian corresponding to the adjacency matrix W

L_{W}=diag(W·1)−W.

Let F=(F_{X}, F_{Y})^{T}. Therefore, L_{CW}(F_{X}, F_{Y}, W^{(X,Y)})=F^{T}LF. More generally, xᵢ, xᵢ₊ₖ may be close to each for some or all k≤k₀; where k₀ is a small integer, resulting in a different loss function than the above loss function (e.g., as shown in Equation 18).

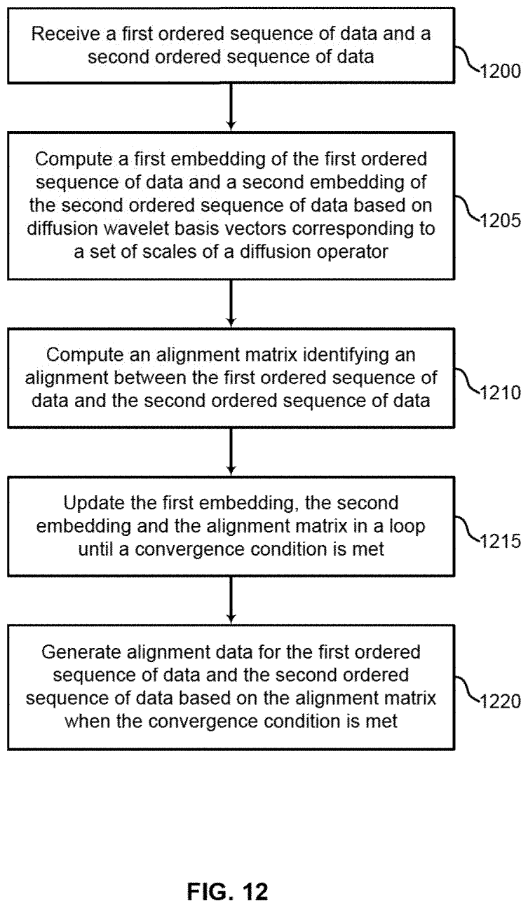

FIG. 12 shows an example of a process for dynamic time warping according to aspects of the present disclosure. In some examples, these operations are performed by a system with a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations. In some aspects, the process for dynamic time warping shown in FIG. 12 may illustrate one or more aspects of WOW parameters and WOW computations described in more detail herein (e.g., with reference to FIG. 10).

At operation 1200, the system receives a first ordered sequence of data and a second ordered sequence of data. In some cases, the operations of this step refer to, or may be performed by, an input component as described with reference to FIG. 1.

At operation 1205, the system computes a first embedding of the first ordered sequence of data and a second embedding of the second ordered sequence of data based on diffusion wavelet basis vectors corresponding to a set of scales of a diffusion operator. In some cases, the operations of this step refer to, or may be performed by, an embedding component as described with reference to FIG. 1.

At operation 1210, the system computes an alignment matrix identifying an alignment between the first ordered sequence of data and the second ordered sequence of data. In some cases, the operations of this step refer to, or may be performed by, a warping component as described with reference to FIG. 1.

At operation 1215, the system updates the first embedding, the second embedding and the alignment matrix in a loop until a convergence condition is met. In some cases, the operations of this step refer to, or may be performed by, an embedding component as described with reference to FIG. 1.

At operation 1220, the system generates alignment data for the first ordered sequence of data and the second ordered sequence of data based on the alignment matrix when the convergence condition is met. In some cases, the operations of this step refer to, or may be performed by, a warping component as described with reference to FIG. 1.

### EXAMPLE EMBODIMENTS

Accordingly, the present disclosure includes at least the following embodiments.

A method for dynamic time warping is described. Embodiments of the method are configured to receiving a first ordered sequence of data and a second ordered sequence of data, generating diffusion wavelet basis vectors at a plurality of scales, wherein each of the scales corresponds to a power of a diffusion operator, computing a first embedding of the first ordered sequence of data and a second embedding of the second ordered sequence of data based on the diffusion wavelet basis vectors, generating alignment data for the first ordered sequence of data and the second ordered sequence of data by performing dynamic time warping based on the first embedding and the second embedding, and transmitting the alignment data in response to receiving the first ordered sequence of data and the second ordered sequence of data.

An apparatus for dynamic time warping is described. The apparatus includes a processor, memory in electronic communication with the processor, and instructions stored in the memory. The instructions are operable to cause the processor to receive a first ordered sequence of data and a second ordered sequence of data, generate diffusion wavelet basis vectors at a plurality of scales, wherein each of the scales corresponds to a power of a diffusion operator, compute a first embedding of the first ordered sequence of data and a second embedding of the second ordered sequence of data based on the diffusion wavelet basis vectors, generate alignment data for the first ordered sequence of data and the second ordered sequence of data by performing dynamic time warping based on the first embedding and the second embedding, and transmit the alignment data in response to receiving the first ordered sequence of data and the second ordered sequence of data.

A non-transitory computer readable medium storing code for dynamic time warping is described. In some examples, the code comprises instructions executable by a processor to: receive a first ordered sequence of data and a second ordered sequence of data, generate diffusion wavelet basis vectors at a plurality of scales, wherein each of the scales corresponds to a power of a diffusion operator, compute a first embedding of the first ordered sequence of data and a second embedding of the second ordered sequence of data based on the diffusion wavelet basis vectors, generate alignment data for the first ordered sequence of data and the second ordered sequence of data by performing dynamic time warping based on the first embedding and the second embedding, and transmit the alignment data in response to receiving the first ordered sequence of data and the second ordered sequence of data.

A system for dynamic time warping is described. Embodiments of the system are configured to receiving a first ordered sequence of data and a second ordered sequence of data, generating diffusion wavelet basis vectors at a plurality of scales, wherein each of the scales corresponds to a power of a diffusion operator, computing a first embedding of the first ordered sequence of data and a second embedding of the second ordered sequence of data based on the diffusion wavelet basis vectors, generating alignment data for the first ordered sequence of data and the second ordered sequence of data by performing dynamic time warping based on the first embedding and the second embedding, and transmitting the alignment data in response to receiving the first ordered sequence of data and the second ordered sequence of data.

Some examples of the method, apparatus, non-transitory computer-readable medium, and system described above further include identifying the diffusion operator based on a Laplacian matrix. Some examples further include computing a plurality of dyadic powers of the diffusion operator. Some examples further include generating an approximate QR decomposition for each of the dyadic powers of the diffusion operator, wherein the diffusion wavelet basis vectors are generated based on the approximate QR decomposition.

Some examples of the method, apparatus, non-transitory computer-readable medium, and system described above further include computing a cost function based on MLE, wherein the first embedding and the second embedding are computed based on the cost function. Some examples of the method, apparatus, non-transitory computer-readable medium, and system described above further include computing a cost function based on a multiscale LPP, wherein the first embedding and the second embedding are computed based on the cost function.

Some examples of the method, apparatus, non-transitory computer-readable medium, and system described above further include computing a WOW loss function, wherein the alignment data is generated based on the WOW loss function.

In some examples, the first ordered sequence of data and the second ordered sequence of data each comprise time series data. In some examples, the first ordered sequence of data and the second ordered sequence of data each comprise an ordered sequence of images. In some examples, the first embedding and the second embedding are based on a mixed manifold embedding objective function. In some examples, the first embedding and the second embedding are based on a curve wrapping loss function. In some examples, the diffusion wavelet basis vectors comprise component vectors of diffusion scaling functions corresponding to the plurality of scales.

A method for dynamic time warping is described. Embodiments of the method are configured to receiving a first ordered sequence of data and a second ordered sequence of data, computing a first embedding of the first ordered sequence of data and a second embedding of the second ordered sequence of data based on diffusion wavelet basis vectors corresponding to a plurality of scales of a diffusion operator, computing an alignment matrix identifying an alignment between the first ordered sequence of data and the second ordered sequence of data, updating the first embedding, the second embedding and the alignment matrix in a loop until a convergence condition is met, and generating alignment data for the first ordered sequence of data and the second ordered sequence of data based on the alignment matrix when the convergence condition is met.

An apparatus for dynamic time warping is described. The apparatus includes a processor, memory in electronic communication with the processor, and instructions stored in the memory. The instructions are operable to cause the processor to receive a first ordered sequence of data and a second ordered sequence of data, compute a first embedding of the first ordered sequence of data and a second embedding of the second ordered sequence of data based on diffusion wavelet basis vectors corresponding to a plurality of scales of a diffusion operator, compute an alignment matrix identifying an alignment between the first ordered sequence of data and the second ordered sequence of data, update the first embedding, the second embedding and the alignment matrix in a loop until a convergence condition is met, and generate alignment data for the first ordered sequence of data and the second ordered sequence of data based on the alignment matrix when the convergence condition is met.

A non-transitory computer-readable medium storing code for dynamic time warping is described. In some examples, the code comprises instructions executable by a processor to: receive a first ordered sequence of data and a second ordered sequence of data, compute a first embedding of the first ordered sequence of data and a second embedding of the second ordered sequence of data based on diffusion wavelet basis vectors corresponding to a plurality of scales of a diffusion operator, compute an alignment matrix identifying an alignment between the first ordered sequence of data and the second ordered sequence of data, update the first embedding, the second embedding and the alignment matrix in a loop until a convergence condition is met, and generate alignment data for the first ordered sequence of data and the second ordered sequence of data based on the alignment matrix when the convergence condition is met.

A system for dynamic time warping is described. Embodiments of the system are configured to receiving a first ordered sequence of data and a second ordered sequence of data, computing a first embedding of the first ordered sequence of data and a second embedding of the second ordered sequence of data based on diffusion wavelet basis vectors corresponding to a plurality of scales of a diffusion operator, computing an alignment matrix identifying an alignment between the first ordered sequence of data and the second ordered sequence of data, updating the first embedding, the second embedding and the alignment matrix in a loop until a convergence condition is met, and generating alignment data for the first ordered sequence of data and the second ordered sequence of data based on the alignment matrix when the convergence condition is met.

Some examples of the method, apparatus, non-transitory computer-readable medium, and system described above further include identifying a dimension of a latent space, wherein the first embedding and the second embedding comprise embeddings in the latent space. Some examples of the method, apparatus, non-transitory computer-readable medium, and system described above further include identifying a number of nearest neighbors for the diffusion operator, wherein the diffusion wavelet basis vectors are determined based on the number of nearest neighbors.

Some examples of the method, apparatus, non-transitory computer-readable medium, and system described above further include identifying a low-rank embedding hyper-parameter, wherein the first embedding and the second embedding are based on the low-rank embedding hyper-parameter. Some examples of the method, apparatus, non-transitory computer-readable medium, and system described above further include identifying a geometry correspondence hyper-parameter, wherein the first embedding and the second embedding are based on the geometry correspondence hyper-parameter.

An apparatus for dynamic time warping is described. Embodiments of the apparatus are configured to a diffusion wavelet component configured to generate diffusion wavelet basis vectors at a plurality of scales, wherein each of the scales corresponds to a power of a diffusion operator, an embedding component configured to compute the first embedding of a first ordered sequence of data and the second embedding of a second ordered sequence of data based on the diffusion wavelet basis vectors, and a warping component configured to generate alignment data for the first ordered sequence of data and the second ordered sequence of data by performing dynamic time warping based on the first embedding and the second embedding.

A system for dynamic time warping, comprising: a diffusion wavelet component configured to generate diffusion wavelet basis vectors at a plurality of scales, wherein each of the scales corresponds to a power of a diffusion operator, an embedding component configured to compute the first embedding of a first ordered sequence of data and the second embedding of a second ordered sequence of data based on the diffusion wavelet basis vectors, and a warping component configured to generate alignment data for the first ordered sequence of data and the second ordered sequence of data by performing dynamic time warping based on the first embedding and the second embedding.

In some examples, the diffusion wavelet basis vectors are generated using a cost function based on MLE. In some examples, the diffusion wavelet basis vectors are generated using a cost function based on multiscale LPP. In some examples, the diffusion wavelet basis vectors are generated based on a QR decomposition of dyadic powers of the diffusion operator. In some examples, the first embedding, the second embedding, and an alignment matrix that identifies the alignment are iteratively computed until a convergence condition is met.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods and components may be implemented or performed by, e.g., server 115 or user device 105 using hardware or software components that may include a general-purpose processor, a DSP, an ASIC, a FPGA or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media with any medium that facilitates the transfer of code or data. A non-transitory storage medium may be any available medium that can be accessed by a computer. For example, non-transitory computer-readable media can comprise RAM, ROM, electrically erasable programmable read-only memory (EEPROM), compact disk (CD) or other optical disk storage, magnetic disk storage, or any other non-transitory medium for carrying or storing data or code.

Also, connecting components may be properly termed as computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of the medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also, the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for time series alignment, comprising:
receiving a first ordered sequence of data and a second ordered sequence of data;
generating diffusion wavelet basis vectors at a plurality of scales, wherein each of the scales corresponds to a power of a diffusion operator;
computing a first embedding of the first ordered sequence of data and a second embedding of the second ordered sequence of data based on the diffusion wavelet basis vectors;
generating alignment data for the first ordered sequence of data and the second ordered sequence of data by performing dynamic time warping based on the first embedding and the second embedding; and
transmitting the alignment data in response to receiving the first ordered sequence of data and the second ordered sequence of data.

2. The method of claim 1, further comprising:
identifying the diffusion operator based on a Laplacian matrix;
computing a plurality of dyadic powers of the diffusion operator; and
generating an approximate QR decomposition for each of the dyadic powers of the diffusion operator, wherein the diffusion wavelet basis vectors are generated based on the approximate QR decomposition.

3. The method of claim 1, further comprising:
computing a cost function based on multiscale Laplacian eigenmaps (MLE), wherein the first embedding and the second embedding are computed based on the cost function.

4. The method of claim 1, further comprising:
computing a cost function based on a multiscale locality preserving projection (LPP), wherein the first embedding and the second embedding are computed based on the cost function.

5. The method of claim 1, further comprising:
computing a warping on wavelets (WOW) loss function, wherein the alignment data is generated based on the WOW loss function.

6. The method of claim 1, wherein:
the first ordered sequence of data and the second ordered sequence of data each comprise time series data.

7. The method of claim 1, wherein:
the first ordered sequence of data and the second ordered sequence of data each comprise an ordered sequence of images.

8. The method of claim 1, wherein:
the first embedding and the second embedding are based on a mixed manifold embedding objective function.

9. The method of claim 1, wherein:
the first embedding and the second embedding are based on a curve wrapping loss function.

10. The method of claim 1, wherein:
the diffusion wavelet basis vectors comprise component vectors of diffusion scaling functions corresponding to the plurality of scales.

11. A method for time series alignment, comprising:
receiving a first ordered sequence of data and a second ordered sequence of data;
computing a first embedding of the first ordered sequence of data and a second embedding of the second ordered sequence of data based on diffusion wavelet basis vectors corresponding to a plurality of scales of a diffusion operator;
computing an alignment matrix identifying an alignment between the first ordered sequence of data and the second ordered sequence of data;
updating the first embedding, the second embedding and the alignment matrix in a loop until a convergence condition is met; and
generating alignment data for the first ordered sequence of data and the second ordered sequence of data based on the alignment matrix when the convergence condition is met.

12. The method of claim 11, further comprising:
identifying a dimension of a latent space, wherein the first embedding and the second embedding comprise embeddings in the latent space.

13. The method of claim 11, further comprising:
identifying a number of nearest neighbors for the diffusion operator, wherein the diffusion wavelet basis vectors are determined based on the number of nearest neighbors.

14. The method of claim 11, further comprising:
identifying a low-rank embedding hyper-parameter, wherein the first embedding and the second embedding are based on the low-rank embedding hyper-parameter.

15. The method of claim 11, further comprising:
identifying a geometry correspondence hyper-parameter, wherein the first embedding and the second embedding are based on the geometry correspondence hyper-parameter.

16. An apparatus for time series alignment, comprising:
a diffusion wavelet component configured to generate diffusion wavelet basis vectors at a plurality of scales, wherein each of the scales corresponds to a power of a diffusion operator;
an embedding component configured to compute a first embedding of a first ordered sequence of data and a second embedding of a second ordered sequence of data based on the diffusion wavelet basis vectors; and
a warping component configured to generate alignment data for the first ordered sequence of data and the second ordered sequence of data by performing dynamic time warping based on the first embedding and the second embedding.

17. The apparatus of claim 16, wherein:
the diffusion wavelet basis vectors are generated using a cost function based on multiscale Laplacian eigenmaps (MLE).

18. The apparatus of claim 16, wherein:
the diffusion wavelet basis vectors are generated using a cost function based on multiscale locality preserving projection (LPP).

19. The apparatus of claim 16, wherein:
the diffusion wavelet basis vectors are generated based on a QR decomposition of dyadic powers of the diffusion operator.

20. The apparatus of claim 16, wherein:
the first embedding, the second embedding, and an alignment matrix that identifies the alignment are iteratively computed until a convergence condition is met.
